(19) United States
(12) Patent Application Publication
(10) Pub. No.: US 2011/0154182 A1
(43) Pub. Date: Jun. 23, 2011

(54) ELECTRONIC DEVICE AND METHOD FOR PROCESSING SCHEDULED DOCUMENTS

(75) Inventor: YONG CHEN, Shenzhen City (CN)

(73) Assignees: SHENZHEN FUTAIHONG PRECISION INDUSTRY CO., LTD., ShenZhen City (CN); CHI MEI COMMUNICATION SYSTEMS, INC., Tu-Cheng City (TW)

(21) Appl. No.: 12/824,205

(22) Filed: Jun. 27, 2010

(30) Foreign Application Priority Data
Dec. 18, 2009 (CN) 200910311782.X

(51) Int. Cl. G06F 3/14

(52) U.S. Cl. 715/234

(57) ABSTRACT

A system and a method for processing scheduled documents by using an electronic device include setting a prompt mode and determining whether a format of a scheduled document is correct. The method further includes selecting a listed item in a predefined sequence from the scheduled document, and obtaining a time duration of the selected listed item, and sending a trigger command to a timer upon the condition that an instruction to start timing is received. The method further includes timing the time duration of the selected listed item and prompting the user that the time duration of the selected listed item elapses according to the set prompt mode.

### BACKGROUND

1. Technical Field

Embodiments of the present disclosure relate to document management, and in particular, to an electronic device and method for processing scheduled documents.

2. Description of Related Art

Scheduled documents may be used to record some continuous operations that have time sequences. For example, a recipe for cooking a specific food may be recorded as a schedule including a plurality of operations, where each of the operations has its own description, such as a time duration of the operation. Generally, people need to frequently check the operations of the recipe or use an additional timer to reminder himself/herself of the time duration of the operations. It is inconvenient to read the recipe and cook at the same time.

### BRIEF DESCRIPTION OF THE DRAWINGS

FIG. 1 is a block diagram of one embodiment of an electronic device including a schedule processing system.

FIG. 2 is a block diagram of one embodiment of the schedule processing system of FIG. 1.

FIG. 3 is a flowchart of one embodiment of a method for processing scheduled documents of the electronic device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or Assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

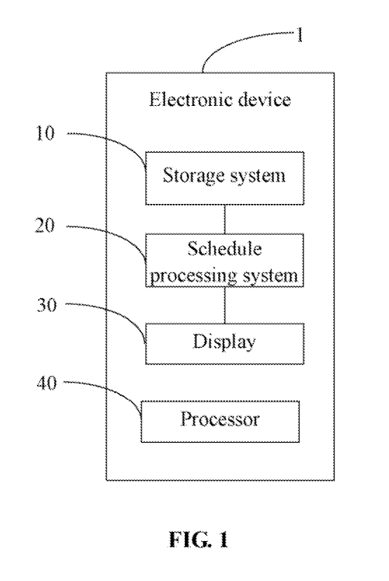

FIG. 1 is a block diagram of one embodiment of an electronic device 1 including a schedule processing system 20. The schedule processing system 20 may automatically send prompt signals of listed items in schedule documents. The electronic device 1 includes a storage system 10, a display 30, and a processor 40. The storage system 10 may store various kinds of data, such as the scheduled documents of the electronic device 1. In some embodiments, the electronic device 1 may be a mobile phone, and the storage system 10 may be a memory of the electronic device 1 and also may be an external storage card, such as a smart media (SM) card or secure digital (SD) card, for example. The processor 40 executes one or more computerized operations of the electronic device 1 and other applications, to provide the functions of the electronic device 1.

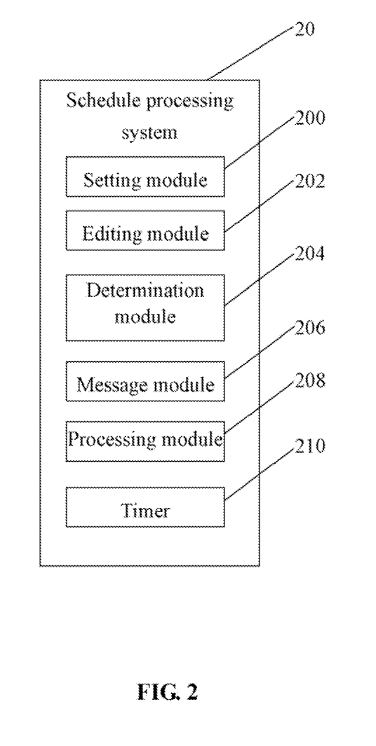

FIG. 2 is a block diagram of one embodiment of the schedule processing system 20 of FIG. 1. In some embodiments, the schedule processing system 20 includes a setting module 200, an editing module 202, a determination module 204, a message module 206, a processing module 208, and a timer 210. The modules 200, 202, 204, 206, 208, and 210 may comprise one or more computerized codes to be executed by the processor 40 to perform one or more operations of the electronic device 1. Details of these operations will be provided below.

The setting module 200 sets a prompt mode of a scheduled document. In some embodiments, the prompt mode may be a phone ring mode, a vibration mode, a flash light mode, and/or a combination of one or more of the above mentioned prompt modes. In some embodiments, the schedule document may be a recipe for cooking a specific food, or an exercise schedule, and/or other documents that have continuous operations and time sequences.

The editing module 202 generates the scheduled document according to preferences input by a user, and edits the scheduled document according to user requirements. The editing module 202 further saves the scheduled document into the storage system 10 or uploads the scheduled document to the Internet. In some embodiments, the scheduled document may be downloaded from the Internet or read from the storage system 10.

For example, the scheduled document adopts a predetermined format: {Begin: Schedule; Version: 1.0; Items: . . . ; END: Schedule}, and has a suffix name “*.sch.” The scheduled document has one or more listed items. Each of the listed items includes a title, a description, and a time duration. The listed items may adopt a predetermined format: {Name=“ . . . ”Description=“ . . . ”Interval=“ . . . ”}. For example, a scheduled document includes three listed items including boiling water, cooking meat, and seasoning. A time duration of the first listed item of “boiling water” is 5 minutes.

The determination module 204 determines whether a format of the scheduled document is correct according to the predetermined format of the scheduled document and the predetermined format of the listed item.

The message module 206 displays an error message on the display 30 to prompt the user that the format of the schedule document is wrong, in response to that the format of the scheduled document is not correct. In some embodiments, the error message may be “Wrong scheduled document format,” for example.

The processing module 208 selects the listed item in a predefined sequence from the scheduled document, and obtains a title, a description and a time duration of the listed item, in response to that the format of the scheduled document is correct. After obtaining the title and the description of the listed item, the processing module 208 displays the title and the description of the selected listed item on the display 30 for the user to check. In addition, the processing module 208 receives an instruction from the user to start timing. For example, the user may click the key “Enter” of the electronic device 1 to start timing Upon receiving the instruction, the processing module 208 sends a trigger command to the timer 210.

The timer 210 times the time duration of the selected listed item. Upon the condition that the time duration of the selected listed item elapses, the message module 206 prompts that the time duration of the selected listed item elapses according to the set prompt mode. In addition, the determination module 204 determines whether the time duration elapses and determines whether there are listed items in the scheduled document that have not been selected. If all of the listed items in the scheduled document are selected, the message module 206 further displays an end message on the display 30 to prompt that the scheduled document is finished. In some embodiments, the end message may be “Task finished.”

In addition, upon the condition that the time duration of the selected listed item elapses, the timer 210 resets.

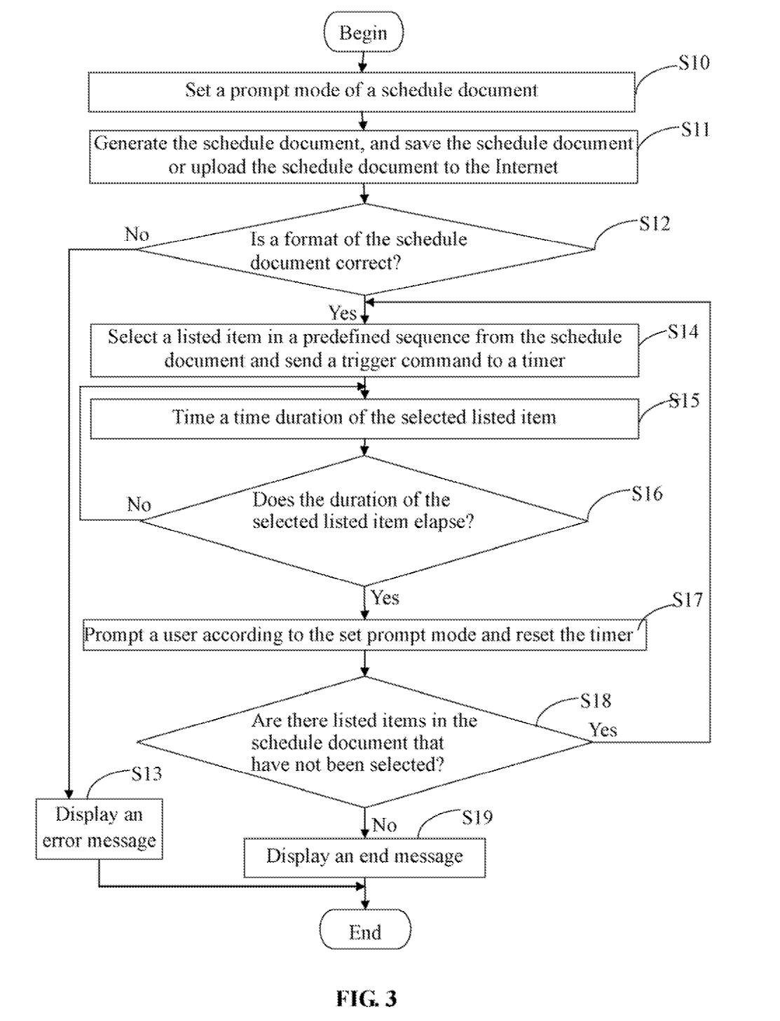

FIG. 3 is a flowchart of one embodiment of a method for processing scheduled documents of the electronic device of FIG. 1. Depending on the embodiment, additional blocks may be added, others removed, and the order of the blocks may be changed.

In block S10, the setting module 200 sets a prompt mode of a scheduled document. As mentioned above, the prompt mode may be a phone ring mode, a vibration mode, a flash light mode, and/or a combination of one or more of the above mentioned prompt modes.

In block S11, the editing module 202 generates the scheduled document according to preferences input by a user, and edits the scheduled document according to user requirements, and then saves the scheduled document into the storage system 10 or uploads the scheduled document to the Internet.

In block S12, the determination module 204 determines whether a format of the scheduled document is correct according to the predetermined format of the scheduled document and the predetermined format of the listed item.

If the format of the scheduled document is not correct, in block S13, the message module 206 displays an error message on the display 30. If the format of the scheduled document is correct, if the format of the scheduled document is correct, in block S14, the processing module 208 selects the listed item in a predefined sequence from the scheduled document. In some embodiments, the processing module 208 obtains a title, a description and a time duration of the listed item. In addition, the processing module 208 further sends a trigger command to the timer 210 in response to receiving the instruction to start timing.

In block S15, if the timer 210 receives the triggering command, the timer 210 times the time duration of the selected listed item.

In block S16, the determination module 204 determines whether the time duration of the selected listed item elapses.

If the time duration of the selected listed item elapses, in block S17, the message module 206 prompts the user that the time duration of the selected listed item elapses according to the set prompt mode and the timer 210 resets. If the time duration of the selected listed item does not elapse, the procedure turns back to the block S15.

In block S18, the determination module 204 determines whether there are listed items in the scheduled document that have not been selected.

If there are listed items in the scheduled document that have not been selected, the procedure turns back to the block S14. If all of the listed items in the scheduled document are selected, in block 19, the message module 206 displays an end message on the display 30 to prompt that the scheduled document is finished.

It should be emphasized that the described disclosed embodiments are merely possible examples of implementations, and set forth for a clear understanding of the principles of the present disclosure. Many variations and modifications may be made to the above-described disclosed embodiments without departing substantially from the spirit and principles of the present disclosure. All such modifications and variations are intended to be comprised herein within the scope of this disclosure and the above-described disclosed embodiments, and the present disclosure is protected by the following claims.

What is claimed is:

1. An electronic device, the electronic device comprising:
a storage system;
a display;
at least one processor; and
one or more programs stored in the storage system and being executable by the at least one processor, the one or more programs comprising:
a determination module operable to determine whether a format of a scheduled document is correct according to a predetermined format of the scheduled document and a format of each listed item in the scheduled document;
a processing module operable to select the listed item in a predefined sequence from the scheduled document and obtain a time duration of the listed item if the format of the scheduled document is correct, and to send a trigger command to a timer of the electronic device;
a message module operable to prompt that the time duration of the selected listed item elapses according to a prompt mode.

2. The electronic device as described in claim 1, wherein the timer is further operable to reset in response to that the time duration of the selected listed item elapses.

3. The electronic device as described in claim 1, wherein the message module is further operable to display an error message on the display when the format of the scheduled document is not correct.

4. The electronic device as described in claim 1, wherein the electronic device further comprises an editing module operable to generate the scheduled document according to input from a user.

5. The electronic device as described in claim 1, wherein:
the determination module is further operable to determine whether there are listed items in the scheduled document that have not been selected; and
the message module is further operable to display an end message on the display upon the condition that all of the listed items in the scheduled document are selected.

6. The electronic device as described in claim 1, wherein the electronic device further comprises a setting module operable to set the prompt mode of the scheduled document, where the prompt mode comprises one or more of a phone ring mode, a vibration mode, and a flash light mode.

7. A method for processing scheduled documents of an electronic device, the method comprising:
determining whether a format of a scheduled document is correct according to a predetermined format of the scheduled document and a format of each listed item in the scheduled document;
selecting the listed item in a predefined sequence from the scheduled document and obtain a time duration of the listed item if the format of the scheduled document is correct, and to send a trigger command to a timer of the electronic device;
timing the time duration of the selected listed item; and
prompting that the time duration of the selected listed item elapses according to a prompt mode upon the condition that the time duration of the selected listed item elapses.

8. The method as described in claim 7, further comprising:
displaying an error message on a display of the electronic device if the format of the scheduled document is not correct.

9. The method as described in claim 7, further comprising:
resetting the timer if the time duration of the selected listed item elapses.

10. The method as described in claim 7, further comprising:
returning to the timing step if the time duration of the selected listed item does not elapse.

11. The method as described in claim 7, further comprising:
generating the scheduled document according to input from a user.

12. The method as described in claim 7, further comprising:
determining whether there are listed items in the scheduled document that have not been selected; and
returning to the selecting step if there are listed items that in the scheduled document that have not been selected; and
displaying an end message on the display if all of the listed items in the scheduled document are selected.

13. The method as described in claim 7, further comprising:
setting a prompt mode of the scheduled document, where the prompt mode comprises one or more of a phone ring mode, a vibration mode, and a flash light mode.

14. A storage medium storing a set of instructions, the set of instructions capable of being executed by a processor to perform a method for processing scheduled documents of an electronic device, the method comprising:
determining whether a format of a scheduled document is correct according to a predetermined format of the scheduled document and a format of each listed item in the scheduled document;
selecting the listed item in a predefined sequence from the scheduled document and obtain a time duration of the listed item if the format of the scheduled document is correct, and to send a trigger command to a timer of the electronic device;
timing the time duration of the selected listed item;
determining whether the time duration of the selected listed item elapses;
prompting that the time duration of the selected listed item elapses according to a prompt mode upon the condition that the time duration of the selected listed item elapses.

15. The storage medium as described in claim 14, further comprising:
displaying an error message on a display of the electronic device if the format of the scheduled document is not correct.

16. The storage medium as described in claim 14, further comprising:
resetting the timer if the time duration of the selected listed item elapses.

17. The storage medium as described in claim 14, further comprising:
returning to the timing step if the time duration of the selected listed item does not elapse.

18. The storage medium described in claim 14, further comprising:
generating the scheduled document according to input from a user.

19. The storage medium as described in claim 13, further comprising:
determining whether there are listed items in the scheduled document that have not been selected; and
returning to the selecting step if there are listed items that in the scheduled document that have not been selected; and
displaying an end message on the display if all of the listed items in the scheduled document are selected.

20. The storage medium as described in claim 14, further comprising:
setting a prompt mode of the scheduled document, where the prompt mode comprises one or more of a phone ring mode, a vibration mode, and a flash light mode.
